(19) United States
(12) Patent Application Publication
(10) Pub. No.: US 2014/0040087 A1
(43) Pub. Date: Feb. 6, 2014

(54) METHOD FOR SENDING OUT MOBILE FINANCIAL SUMMARIES

(71) Applicant: Deon Deon Vand er Vyver, Johannesburg (ZA)

(72) Inventor: Deon Deon Vand er Vyver, Johannesburg (ZA)

(21) Appl. No.: 13/811,668

(22) PCT Filed: Jan. 14, 2011
(86) PCT No.: PCT/ZA2011/000002

§ 371 Date: Jul. 8, 2013

(30) Foreign Application Priority Data
Jan. 10, 2000 (ZA) 2000/0009
Feb. 8, 2000 (ZA) 2000/0559

(51) Int. Cl. G06Q 40/02

(52) U.S. Cl. CPC G06Q 40/02
USPC 705/35

(57) ABSTRACT

The invention provides for a financial summary system and more particularly relates to a system for sending out invoices and/or statements via a multi-media messaging service (MMS).

### BACKGROUND TO THE INVENTION

This invention relates to a financial summary system and more particularly relates to a system for sending out invoices and/or statements via a multi-media messaging service (MMS).

Multimedia messaging service is a telecommunications standard for sending messages that includes multimedia objects (images, audio, video, rich text). MMS is an extension of the Short message service (SMS) standard, allowing longer message lengths and using WAP to retrieve the content.

Its most popular use is sending photographs from camera equipt handsets, although it is also popular as a method of delivering ringtones.

It is common cause and that the use of technologies such as Internet and wireless communication networks is the norm of the future. However, even today many businesses utilise old means for communication such as sending out letters and statements via post and courier services.

The problem with making use of older communication is that it is time-consuming and costly. Furthermore, there is a substantial time delay between the sending and receiving of such communications.

A further problem generally associated with sending communication via facsimile or post is the confidentiality and security factors. It quite often happens that correspondence is lost or stolen and adds to the frustration of the sender as well as the recipient.

This is especially a problem when confidential information is communicated to the intended recipient. As information can easily be “hijacked”, the confidentiality of the information to be communicated is at great risk.

It is an object of the current invention to at least partially alleviate some of the aforementioned problems.

### SUMMARY OF THE INVENTION

The invention provides for a method of sending out mobile financial summaries which method includes the steps of requesting, by means of a request processor, a financial summary from a multimedia messaging service (MMS) processor; authenticating the validity of the request by means of a security module; generating a financial summary by utilising a multiple overlay technique and transmitting the financial summary to a response processor.

The request processor may be any suitable handheld device such as a personal assistant digital (PDA), cellular telephone, alternatively may be a computer or Automated Teller Machine (ATM).

The response processor may be in communication with a report module which in turn may be in communication with an end user but preferably is in communication with a suitable device of an end user such as a personal assistant digital (PDA), cellular telephone, a computer or any combination of the aforementioned.

The security module may include any one of or combination of the following validation steps: validating if a request is received from a WAP gateway; validating Mobile Station International Subscriber Directory Number (MSISDN) (Cell Phone number); validating MSISDN or validating a personal identification number or password. In the event that any of the validation steps fails, an error message may be communicated to the request processor alternatively to the response processor.

The method may further include the steps of transmitting the financial summary from the response processor to an end user, alternatively a device such as a personal assistant digital (PDA), cellular telephone, or a computer used by the end user.

The device utilised by the end user such as a personal digital assistant (PDA), cellular telephone, or a computer is validated by first removing all non-numeric values and then appending the international country code if missing.

The method yet further includes the steps of determining the destination Network by validating the mobile device number against predefined network data and querying the National Mobile Number Portability database to determine if a number has been ported to a different service provider.

The capability of the mobile device is determined by determining the User Agent Profile or an International Mobile Equipment Identity (IMEI) number as created by the manufacturer; comparing the requested information with an internal User Agent Profile data repository and returning specific information such as the screen width, screen height, MMS support, Image support, Video support, Flash support or any combination of the aforementioned.

The statement processor may include a data store in which data of various clients may be stored. The statement processor may further include and be in communication with an upload module, XML module, a content module or any combination of the aforementioned.

The financial summary may include any financial information of a client, alternatively an end user and more particularly may include information such as an invoice, statement, debit note, credit note or any combination of the aforementioned. The financial summary may be displayed in accordance with a client's specific requirements, the specific requirement of the end user, alternatively as required by governing law.

The upload module may include uploaded files from the client, of which each file may be assigned a unique identification means to prevent duplication.

The XML module may parse and retrieve XML documents from the data store and return such data in a XML format.

The content module may parse and format each request to ensure compatibility with the various handheld devices and may include any one of or combination of the following output methods: SMS, MMS, Mobi Site and XML.

The report module may yet further be in communication with the data store and may be responsible for dynamic report generation. The report module may further include a default report selection, but may also include a customer preference report. The customer preference report may include anyone of or combination of the following parameters: client credentials, report number and customer filters.

The multimedia messaging service (MMS) processor, also referred to as a MMS assembler may utilise a creative design module, data from an Extract Translate Load (ETL) and from a Data Preparation service to generate a financial summary.

The financial summary may be generated by utilising an overlay technique in which text is overlaid by image or vice versa. The overlay may further increase security as it is more difficult to tamper with the text to image overlay. In general the financial summary information is overlaid onto a base image template which may contain the client's brand, logo and or corporate identity.

The creative design module may be a design specifically specified by the end user, alternative the client, or any combination of the aforementioned and may include information such as corporate identity, unique numbers, VAT numbers, Invoice, Numbers, Credit Note Numbers, Debit Note Numbers, Statement Numbers, Transaction Dates, Purchase information, Credit information or any combination of the aforementioned. It will be appreciated that any alternate relevant info can be included in the creative design module.

The Extract Translate Load (ETL) module may be utilised to automate the process of extracting data from various sources and translates the received data in a common statement format that is recognised by the MMS assembler.

The data preparation may include the extracting of the mobile numbers from the ETL and validating the mobile numbers, confirming which mobile operator or service provider the specific number is assigned to and determining the associated handheld device's capabilities.

The response processor may include a result module and an error module. The result module, may log and format errors that occur while executing any modules or processes and may be a result message which may either be a string or a record set containing the report information. The output format of the result module may be Text, HTML, XML or any combination of the aforementioned.

The error module may log and format errors that occur while executing modules and processes and may be an error message. The output format of the error message may be Text, HTML, XML or any combination of the aforementioned.

### BRIEF DESCRIPTION OF THE DRAWINGS

The invention is now further described by way of example with reference to the accompanying drawing wherein:

FIG. 1 is a flow diagram of the method steps according to the invention;

FIG. 2 is a flow diagram of the Security module according to the invention;

FIG. 3 is a flow diagram of the Upload module of the invention;

FIG. 4 is a flow diagram of the XML module of the invention;

FIG. 5 is a flow diagram of the Content module of the invention;

FIG. 6 is a flow diagram of the Reporting module of the invention;

FIG. 7 is a flow diagram of the Result module of the Invention; and

FIG. 8 is a flow diagram of the Error module of the invention.

### DESCRIPTION OF PREFERRED EMBODIMENTS

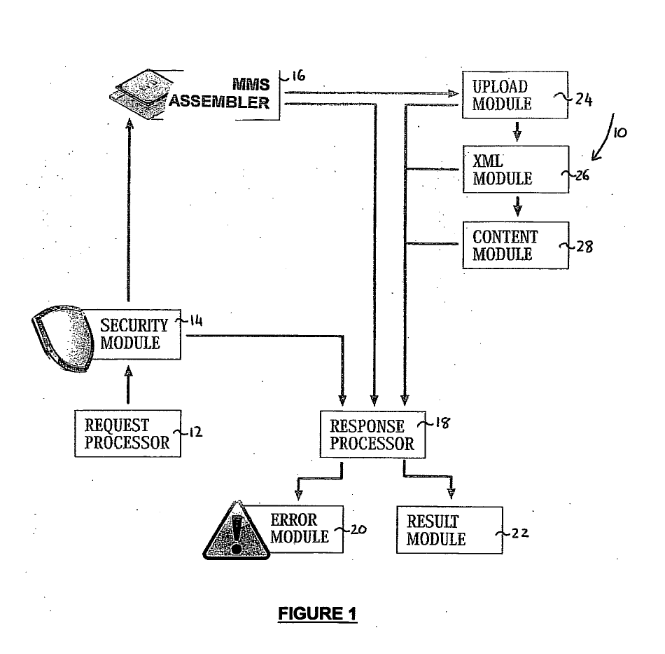

FIG. 1 illustrates a flow diagram of a method for sending out mobile financial summaries 10 which consists of a request processor 12 a security module 14 in communication with the request processor 12, a multimedia messaging service (MMS) processor 16 in communication with the security module 14 and a response processor 18 in communication with the MMS processor 16.

The response processor 18 consists of an error of module 20 and a result module 22. The MMS processor 16 is also in communication with an upload module 24 which in turn is in communication with a XML module 26 and content module 28.

In one embodiment of the invention, a request is transmitted via the request processor 12 to a security module 14 for verification purposes before the request is transmitted to the MMS processor 16.

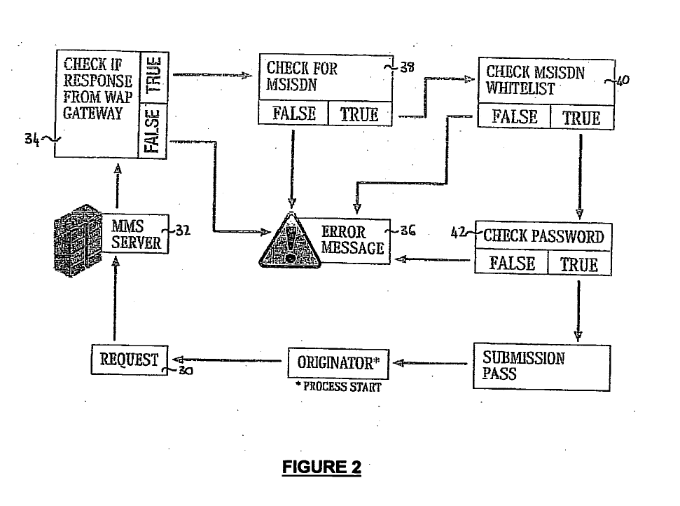

The security module 14 includes a four stage verification process as is more clearly illustrated in FIG. 2. The request 30 is transmitted to a MMS server 32 followed by a four stage of verification process.

During the first stage 34 a validation is done to the terminal with the response from a WAP gateway. In the event that the response is not from a WAP gateway (false) an error message 36 is transmitted. In the event that the response is from a WAP gateway (true) a second stage 38 validation is conducted.

During the second validation stage 38 a validation is done for MSISDN. In the event that the validation is false an error message 36 is transmitted. In the event that the validation is true a third stage validation 40 is conducted.

During the third stage validation 40 the MSISDN white list is validated. In the event that the validation is false an error message 36 is transmitted. In the event that the validation is true a fourth and final stage 42 validation is done.

During this final stage validation 42 any suitable identification means for example a personal identification number (PIN) or password is utilised for verification purposes. In the event that the personal identification number or password is false an error message 36 is transmitted. In the event that the personal identification number or password is true, the submission is passed and transmitted to the statement processor 16.

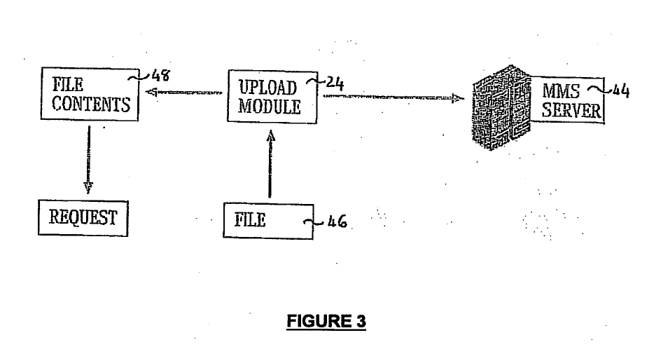

The statement processor 16 is in communication with an upload module 24 and herein before described. The upload module 24 is responsible for transferring files from a client to the MMS server 44 as is more clearly illustrated in FIG. 3.

Each uploaded file 46 is assigned a unique name to prevent any duplication of an exact file. During this stage there are no expected parameters. The upload module 24 will either return a blank file in the event that no uploading of any file contents 48 has occurred, alternatively the physical file contents 48 is returned.

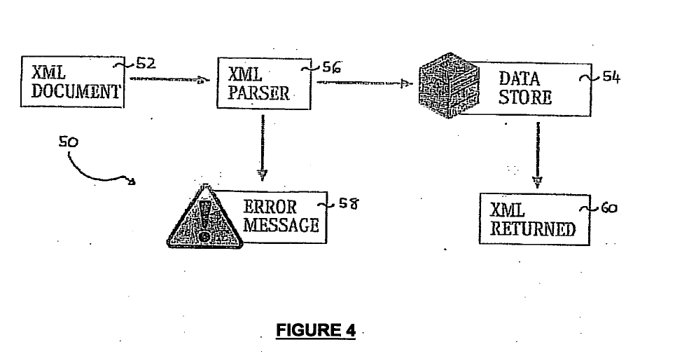

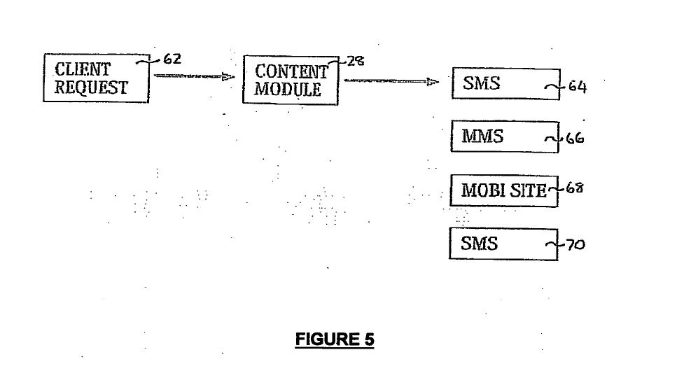

FIG. 4 illustrates the XML module 50. The XML module 50 is responsible for parsing and the retrieval of XML documents 52 into and from the data store 54. The parameter expected is that of a XML document (string). The XML parser 56 is capable to return an error message 58 and is in communication with the data store 54. The XML module 50 will return a XML document 60 containing the results based on the XML document 52 passed.

The content module 28 is responsible for the output of data based on the requirements of the client (client request) 62. Currently, the following output methods are supported: SMS 64, MMS 66, Mobi site 68 and XML 70 as is more clearly illustrated in FIG. 5. Each request 62 is parsed and formatted by the content module 28 to insure compatibility across all handheld devices. This allows for optimised content delivery for each mobile device that either receives or connects to view the requested information.

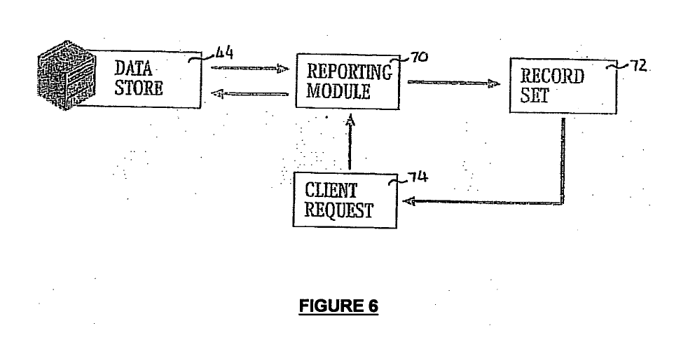

FIG. 6 illustrates a flow diagram of a reporting module 70 which is in communication with the data store 44. The reporting module 70 is responsible for dynamic report generation. A default report is included within the module, and allows for custom user reports. The reporting module 70 returns a record set 72 containing the report data as per the client request 74. The parameter which is expected includes, but is not necessarily limited to, client credentials (security module) and a report number (integer). Various parameters may be optional and includes, but is not necessarily limited to, customer filters (filter module). It will be appreciated by those skilled in the art that many other embodiments exist and that the client will be able to choose the filter options to only display the required information.

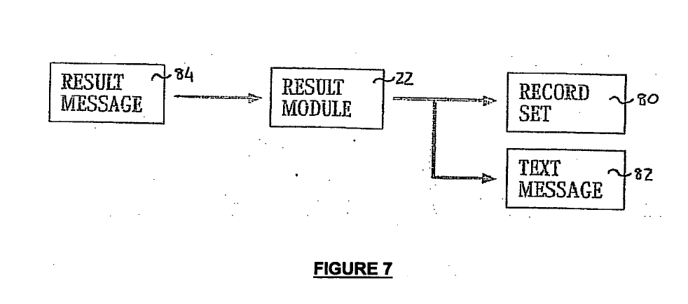

The response processor 18 includes a result module 22 and an error module 20. The result module 22 is responsible for the logging and formatting of errors that occur while executing module or processes. The result module 22 results in a record set 80, alternatively a text message 82 output as is more clearly illustrated in FIG. 7. The parameters expected, but not necessarily limited to, includes a result message (variant), the result message can either be a string or a record set containing report information. The output format includes, but is not necessarily limited to, text, HTML, XML or any combination of the aforementioned. Generally, the result module 22 will return the formatted result message 84 as a string value.

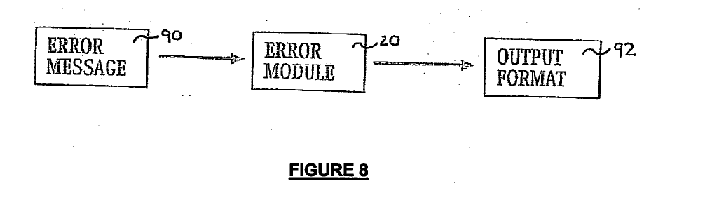

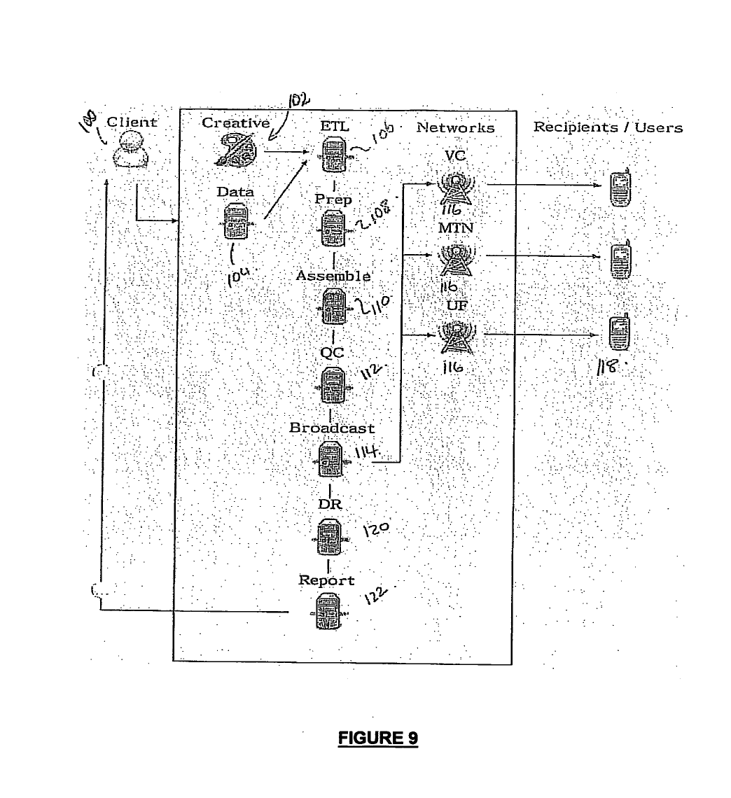

FIG. 8 illustrates a flow diagram of the error module 20. The error module 20 is responsible for the logging and formatting of errors which occurred while executing modules and processes. The parameters expected, but not necessarily limited to, include error message (string) 90 and an output format 92, which includes but is not necessarily limited to, text, HTML, XML or any combination of the aforementioned. The error module 20 will return the formatted error message as a string value.

In a second embodiment of the invention, with particular reference to FIG. 9, a client 100 will submit a request to a Creative Design module 102 to design the particular financial summary such as a statement or invoice. The client's 100 specific requirements are included in the design and may include information such as the client's logo, the customer name, surname, VAT numbers, invoice numbers and the like. Please note that the particular information hereinbefore said is not by any means limiting.

The client 102 may communicate directly with the creative design module 100 and design his own criteria, alternatively the creative design may be done by a developer (not shown) on behalf of the client.

The creative design module utilises creative templates to formalise the specific customer design. The creative design templates are designed for, but not necessarily limited to the following types of handsets:

320×240—High Resolution

320×240—Low Resolution

240×320—High Resolution

240×320—Low Resolution

128×160—High Resolution

160×128—High Resolution

Generally, the client will submit sample data 104 to be utilised by the creative design module 102 to create a particular financial summary as per client satisfaction.

Once the creative design has been approved, required data fields are mapped to the data sample 104 and a data contact (not shown) is drawn up. The data contract defines how the information pertaining to the financial summary will be obtained from the client 100, alternative from the client's customers. For example, the necessary information may be pulled from the clients website via SFTP, alternatively may be pushed to a designated server as well as the format in which the data will be received (e.g. CSV, XML, XLS or the like) and the type of information contained in the file.

In the likely event that encryption on the data exists, the encryption details (excluding the shared key) are also defined. The data contract also describes how an individual is identified in the data for example by means of identification number or by customer demand.

Dependent on the data 104 received, the extract translate load (ETL) 106 process is built. The ETL 106 automates the process of extracting the data from the source. The extracted data is translated in a common statement format that is recognised by an MMS assembler 110. The data is securely stored in a repository. An example may be a database.

The data preparation 108 is done by extracting the necessary information from the ETL data 106 and compiling same by means of a data preparation service.

The data preparation service confirms and authenticates that the mobile numbers are valid and associates the said mobile numbers with a particular service provider. The prepared information is transmitted to the MMS assembly 110.

During the data preparation 108 the validity of the mobile number is determined by first removing any non-numeric values and appending the international country code if missing.

The destination network and more particularly the relevant service provider are determined by validating the mobile number against a predefined pattern to determine likely destination networks. Furthermore, a query is submitted to the National mobile number portability database to determine if the numbers have been ported to a different service provider.

Lastly, the handset capability is also determined during the data preparation 108. Each handset is provided with a user agent profile as well as an International Mobile Equipment Identity (IMEI) number by the manufacturer. The capability of the handheld device is utilised to generate a financial summary to comply and be displayed on the relevant mobile device. Typical information which is relevant to the particular mobile device will include but is not necessarily limited to, screen width, screen height, MMS support, image support, video support, Flash support or any combination of the aforementioned.

During the MMS assembly stage 110 the MMS assembler uses the creative design 102, the data from the ETL 106 and results from the data preparation 108 to generate an electronic financial summary. Preferably, the financial summary is a invoice, statement, Credit Note, Debit Note, or any combination of the aforementioned.

The MMS assembly 110 utilises the following steps to create the electronic financial summary:
a. Base creative templates are selected based on a recipient handset capability;
b. statement information is overlaid onto the base image template containing the client's brand, logo and/or corporate identity;
c. a presentation, alternatively slideshow is created by combining multiple overlaid images with delays in between each;
d. by overlaying the text onto the image, the layout is controlled to enable better presentation to the user as well as the recipient.

Utilising a text to image overlay further enhances security and provides ease of mind for the recipient.

In the likely event that the recipient, alternatively the client would like to make the electronic financial summary available on a mobi site, the link to the Mobi site is included. The said link can be personalised and can be secured by using online data security.

In general, all the electronic financial summaries will include a sign or mark of authentication.

Random samples are submitted from the MMS assembler 110 to quality control 112. Quality control is conducted by randomly sending electronic financial summaries to a plurality of lab phones for viewing. The information contained in the MMS is checked and compared to the original data received from the client to check accuray.

Once the internal quality control has been approved the batch is transmitted to the client for final approval. Upon approval of the client 100, the MMS assembler 110 is tasked with creating MMS messages in the form of a proprietary XML language. The individual messages are grouped based on the destination network.

Thereafter the messages are submitted to the broadcast module 114 which in turn submits the messages to the network operators or service providers via HTTP or HTTPS in a MM7/MM3 format, protocols defined by the third generation partnership group (3GP) or submitted to service provider in a service provider specific format.

The MMS packets may contain a synchronised multimedia integration language (SMIL) file defining the presentation as described hereinbefore. All images are included as attachments and are embedded into the MMS that is transmitted to the operator or service provider.

The operator or service provider may acknowledge receipt of the messages by responding with a unique reference number. In case of failure, messages are transmitted for a number of times more before they are deemed to have failed permanently. Once the operator or service provider acknowledges receipt of the message, the original MMS declaration is discarded for security purposes.

At this point the operator or service provider 116 can distribute the MMS message to the end user 118 via the secured GSM, alternatively 3G network.

Upon receipt of the message by the end user, the relevant handset or mobile device is requested to send out a delivery receipt back to the operator or service provider 116. This functionality forms part of the MMS technology specification as defined by the third generation partnership group (3GP). The operator or service provider 116 passes this information on to the host 120 for storage and future use.

Lastly a report is generated by a report processor 122 which is sent to the client 100 at periodic intervals. The report generally includes information pertaining to the number of messages sent, number of messages delivered to the handset or mobile device, and a number of messages that fail to be delivered. It will be appreciated by those skilled in the art that the reports may contain any relevant information relating to the process and is by no means limited to the information hereinbefore mentioned.

In general, a client will request the Mobi site from an Internet ready mobile device. The request will first be processed by the security module 14 and depending on the verification request, will be communicated to the mobile device via a MobiEngine Module. The MobiEngine module will be responsible for translating and processing any data to best accommodate the graphics requirements for the mobile device.

It will be appreciated by those skilled in the art that many other embodiments exist which fall within the scope of the current invention. For example, any suitable means of verification may be utilised to validate a client and the perspective request. Furthermore, any information may be uploaded to the data store, which information may then be requested by the client, and which is transmitted to the client by means of a multi-messaging service (MMS). However, the current invention particularly relates to the requesting of a financial summary by the client, which is transmitted to the client by means of a MMS.

1. A method of sending out mobile financial summaries, the method comprising:
requesting, by means of a request processor, a financial summary from a multimedia messaging service (MMS) processor;
authenticating the validity of the request by means of a security module;
generating a financial summary by utilizing a multiple overlay technique; and
transmitting the financial summary to a response processor.

2. The method of claim 1 wherein the request processor is a handheld device.

3. The method of claim 2 wherein the handheld device is a personal digital assistant (PDA), a cellular phone, a computer, an Automated Teller Machine, or any combination thereof.

4. The method of claim 1 wherein the response processor is in communication with a report module.

5. The method of claim 4 wherein the report module is in communication with the handheld device.

6. The method of claim 5 wherein the handheld device is a cellular telephone, a computer, a PDA or any combination thereof.

7. The method of claim 1 wherein the security module includes any one of or combination of the following steps:
Authenticating the validity when a request is received from a WAP gateway;
Authenticating the validity by means of a Mobile Station International Subscriber Directory Number (MSISDN) (Cellular telephone number);
Authenticating the validity by means of a MSISDN; and
Authenticating the validity by means of a personal identification number or password.

8. The method of claim 7 wherein an error message is communicated to the request processor alternatively to the response processor should any one of or combination of the steps of authenticating the validity fail.

9. The method of claim 1 further comprising the step of transmitting the financial summary from the response processor to a handheld device utilized by an end user.

10. The method of claim 9 wherein the handheld device is any of a personal assistant digital (PDA), a cellular telephone, or a computer.

11. The method of claim 9 wherein the handheld device is validated by first removing all non-numeric values and then appending an international country code if missing.

12. The method of claim 11 wherein the method further comprises the step of determining a destination Network by validating a number associated with the mobile device against predefined network data and querying a National Mobile Number Portability database to determine if the number has been ported to a different service provider.

13. The method of claim 12 wherein the capability of the mobile device is determined by determining a User Agent Profile or an International Mobile Equipment Identity (IMEI) number as created by the manufacturer; comparing the requested information with an internal User Agent Profile data repository; and returning specific information including any of a screen width, screen height, MMS support, Image support, Video support, Flash support or any combination of the aforementioned.

14. The method of claim 1 wherein the statement processor includes a data store in which data of various clients are stored.

15. The method of claim 14 wherein the statement processor includes and is in communication with an upload module, an XML module, a content module or any combination of the aforementioned.

16. The method of claim 15 wherein the upload module uploads files from a client, wherein each uploaded file is assigned a unique identification means to prevent duplication.

17. (canceled)

18. The method of claim 15 wherein the XML module parses and retrieves XML documents from the data store and returns such data in a XML format.

19. The method of claim 15 wherein the content module parses and formats each request to ensure compatibility with various handheld devices capable of supporting any one of or combination of the following output methods: SMS, MMS, Mobi Site and XML.

20. (canceled)

21. The method of claim 15 wherein:
the report module is in communication with the data store and is responsible for dynamic report generation;
the report module includes a default report selection and a customer preference report; and
the customer preference report includes information as per a customer specification including any of client credentials, report number, customer filters or any combination thereof.

22-28. (canceled)

29. The method of claim 1 wherein the MMS processor utilizes a creative design module, data from an Extract Translate Load (ETL) and data from a Data Preparation service to generate the financial summary using an overlay technique, wherein:
the overlay technique comprises overlaying financial summary information onto a base image template containing a client's brand, logo and or corporate identity or any combination thereof;
the creative design module includes end-user or client-specific information comprising any of a corporate identity, a unique numbers, a VAT number, an invoice numbers, a credit note numbers, a debit note number, a statement number, a transaction date, purchase information, and credit information; and
the Extract Translate Load (ETL) module automates the process of extracting data from various sources and translates received data in a common statement format that is recognized by the MMS assembler.

30-43. (canceled)
